(19) United States
(12) Patent Application Publication
(10) Pub. No.: US 2022/0139621 A1
(43) Pub. Date: May 5, 2022

(54) MULTI-LAYER CERAMIC CAPACITOR STRUCTURE AND MANUFACTURING METHOD THEREOF

(71) Applicants: Wei-Lin TSENG, Taipei City (TW); Amazing Cool Technology Corp, Taipei City (TW)

(72) Inventors: Wei-Lin TSENG, Taipei City (TW); Yang-Ming SHIH, Taipei City (TW); Hung-Yun HSU, Taipei City (TW)

(21) Appl. No.: 17/084,426

(22) Filed: Oct. 29, 2020

(51) Int. Cl. H01G 4/12; H01G 4/30; H01G 4/008

(52) U.S. Cl. CPC H01G 4/1209; H01G 4/008; H01G 4/30

(57) ABSTRACT

The invention provides a manufacturing method for a multi-layer ceramic capacitor. the method includes: providing a plastic film; coating a layer of ceramic slurry on a side of the plastic film; coating a layer of copper paste on the layer of ceramic slurry to form a raw material, wherein the copper paste includes a copper powder and a graphene powder; and sintering the raw material at a temperature equal to or higher than 800° C. to sinter the layer of ceramic slurry into a ceramic dielectric layer and the copper paste into a copper electrode layer. The copper atoms are restricted by the graphene so that the copper atoms are confined in layer arrangement to improve flatness of copper atoms in the copper electrode layer.

### BACKGROUND OF THE INVENTION

### Technical Field

The invention relates to multi-layer capacitors, particularly to a multi-layer ceramic capacitor structure modified by graphene and a manufacturing method thereof.

### Related Art

A current method for manufacturing a multi-layer ceramic capacitor coats copper paste on a ceramic dielectric layer and then sinters the ceramic dielectric layers which have been laminated. The sintered copper paste forms copper electrode layers in the ceramic. The copper electrode layers are laminated layer so that the copper electrode layers can be used to store charges to serve as a capacitor.

The current method has the following drawbacks. Copper paste melts in the sintering process and infiltrates gaps in a surface of the ceramic dielectric layer so as to make the copper electrode layer uneven. This will reduce charge storing ability of the capacitor. As a result, some products of mass-production cannot reach a required charge storing ability and cause a bad yield rate.

In view of this, the inventors have devoted themselves to the above-mentioned prior art, researched intensively and cooperated with the application of science to try to solve the above-mentioned problems. Finally, the invention which is reasonable and effective to overcome the above drawbacks is provided.

### SUMMARY OF THE INVENTION

The invention provides a multi-layer ceramic capacitor structure modified by graphene and a manufacturing method thereof

The invention provides a manufacturing method for a multi-layer ceramic capacitor structure, which includes the steps of: providing a plastic film; coating a layer of ceramic slurry on a side of the plastic film; coating a layer of copper paste on the layer of ceramic slurry to form a raw material, wherein the copper paste includes a copper powder and a graphene powder; and sintering the raw material at a temperature equal to or higher than 800° C. to sinter the layer of ceramic slurry into a ceramic dielectric layer and the copper paste into a copper electrode layer.

In the method of the invention, the plastic film is of a strip shape, the raw material forms a material roll, the raw material roll is cut to be multiple raw material sheets, and the raw material sheets are laminated to be a multi-layer structure in the same direction and the multi-layer structure is sintered.

In the method of the invention, the raw material is sintered at a temperature equal to or lower than 1100° C.

In the method of the invention, the raw material is sintered to evaporate the plastic film.

In the method of the invention, the copper paste includes filled plastic material and the raw material is sintered to evaporate the plastic material.

In the method of the invention, the copper powder includes multiple copper atoms, the graphene powder includes multiple graphene molecules, every six of the graphene molecules are bonded to form a ring structure, and an inner side of each ring structure is bonded with five copper atoms. An outer side of each ring structure is bonded to another ring structure The ring structures are planarly extended and connected. The ring structures are arranged in a laminated manner.

In the method of the invention, a weight percentage of the copper powder contained in the copper paste is between 50% and 65%.

The invention also provides a multi-layer ceramic capacitor structure, which includes: a multi-layer structure. The multi-layer structure includes multiple ceramic dielectric layers which are laminated, and a copper electrode layer being sandwiched between any adjacent two of the ceramic dielectric layers. The coper electrode layer includes multiple graphene molecules and multiple copper atoms. The graphene molecules and the copper atoms are connected and arranged laminatedly.

In the multi-layer ceramic capacitor structure of the invention, every six of the graphene molecules are bonded to form a ring structure, and an inner side of each ring structure is bonded with five copper atoms. An outer side of each ring structure is bonded to another ring structure.

The ring structures are planarly extended and connected. The ring structures are arranged in a laminated manner.

The multi-layer ceramic capacitor structure of the invention further includes a pair of outer electrodes respectively covering a pair of side edges of the multi-layer structure, one of the outer electrodes connects to a part of the copper electrode layer, and another one of the outer electrodes connects the rest of the copper electrode layers.

The multi-layer ceramic capacitor structure and manufacturing method thereof of the invention confines copper atoms in a layer arrangement to improve flatness of copper atoms in the copper electrode layer by restricting copper atoms with graphene molecules.

### BRIEF DESCRIPTION OF THE DRAWINGS

FIG. 1 is a flowchart of the manufacturing method for a multi-layer ceramic capacitor of an embodiment of the invention;

FIGS. 2-6 are schematic views of the steps of the manufacturing method for a multi-layer ceramic capacitor of an embodiment of the invention;

FIG. 7 is a schematic view of the connecting structure of graphene and copper atoms of the multi-layer ceramic capacitor of an embodiment of the invention; and

FIG. 8 is a schematic view of the multi-layer ceramic capacitor of an embodiment of the invention.

### DETAILED DESCRIPTION OF THE INVENTION

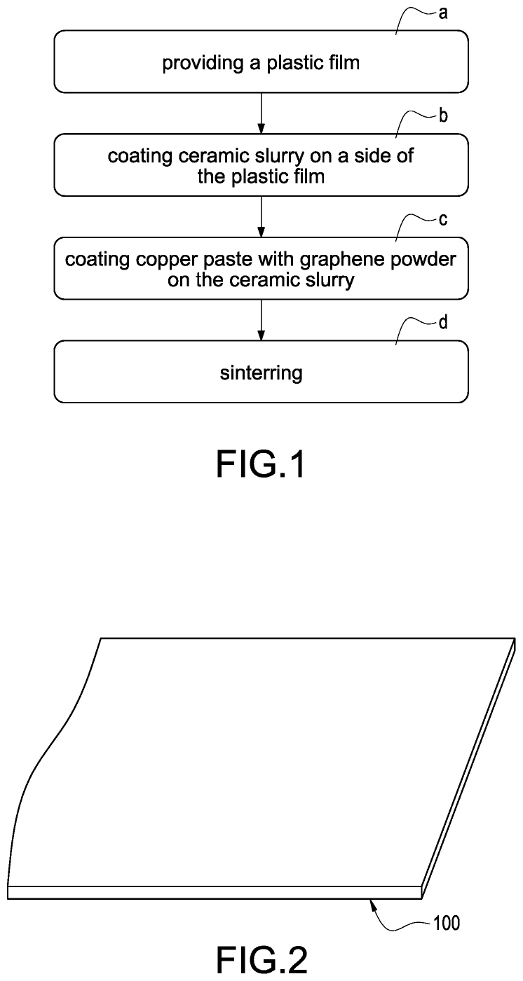

Please refer to FIG. 1. The invention provides a manufacturing method for a multi-layer ceramic capacitor structure, which includes the following steps.

Please refer to FIGS. 1 and 2. In step a), a plastic film 100 is provided. In this embodiment, the plastic film 100 is preferably a strip shape.

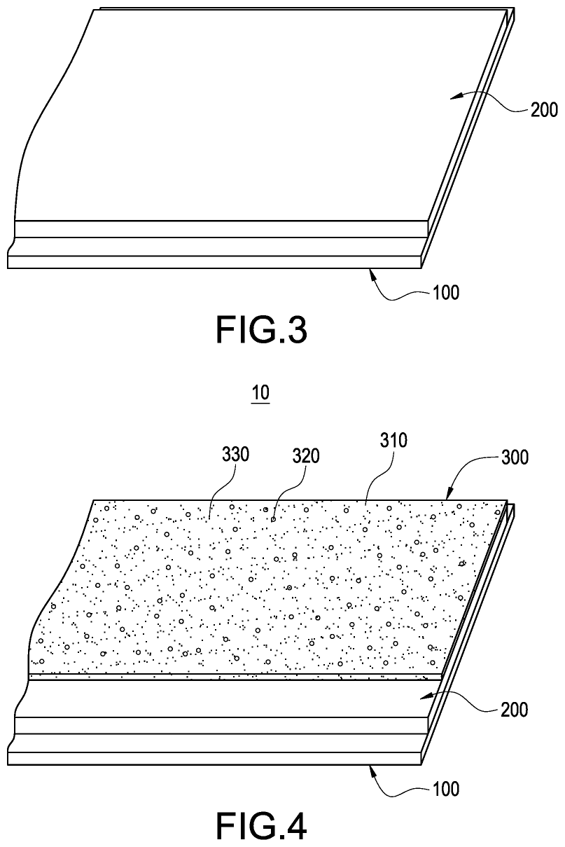

Please refer to FIGS. 1 and 3. In step b), a layer of ceramic slurry 200 is coated on a side of the plastic film 100. The ceramic slurry 200 primarily includes barium titanate.

Please refer to FIGS. 1 and 4. In step c) after step b), a layer of copper paste 300 is coated on the layer of ceramic slurry 200 to form a raw material 10. In this embodiment, the raw material 10 preferably forms a material roll. In this step, the raw material roll is cut to be multiple raw material sheets 11. The copper paste 300 at least includes a copper powder 310 and a graphene powder 320, and further includes filled plastic material 330 serving as a carrier fixing the copper powder 310 and the graphene powder 320. The filled plastic material 330 may be gelatinous plastic, wax or grease. In detail, the weight percentage of the copper powder 310 included in the copper paste 300 is between 50% and 65%. The copper powder 310 includes multiple copper atoms 311 and the graphene powder 320 includes multiple graphene molecules 321.

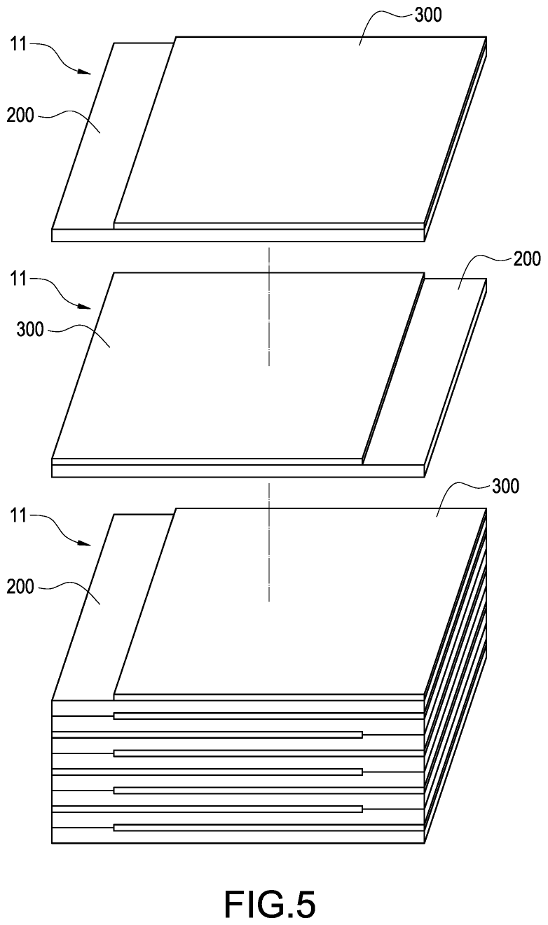

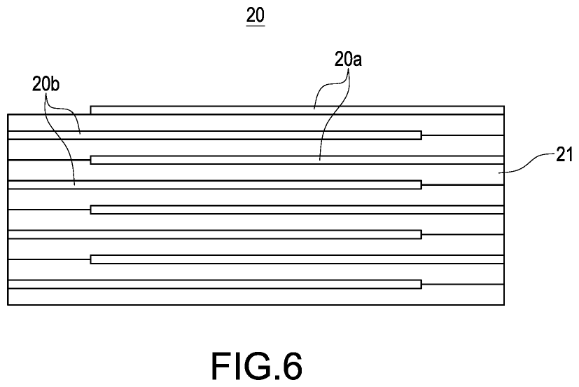

Please refer to FIGS. 1, 5 and 6. In step d) after step c), the raw material 10 is sintered at a temperature equal to or higher than 800° C. to sinter the layer of ceramic slurry 200 into a ceramic dielectric layer 21 and the copper paste 300 into a copper electrode layer 22a, 22b. The sintering temperature at equal to or higher than 800° C. can break the bonds between the graphene molecules 321. Thus, the graphene may be re-arranged to form new bonds. When sintering the raw material 10, both the plastic film 100 and the filled plastic material 330 included in the copper paste 300 are heated up to higher than 300° C. to be evaporated. As shown in FIG. 5, in this step, the raw material sheets 11 are laminated to be a multi-layer structure in the same direction and then the multi-layer structure is sintered. In detail, laminating in the same direction means laminating with copper paste 300 of each raw material sheet 11 facing upward. Also, when sintering, because of the differences between native properties of various materials, under the same sintering conditions, the ceramic slurry 200 forms the ceramic dielectric layer 21 first, and then the copper electrode layer 22a, 22b is formed to compose the structure as shown in FIG. 6. Accordingly, in this step, the raw material 10 is sintered preferably at a temperature equal to or lower than 1100° C. so as to avoid excessive liquidity of melted copper. This may prevent the copper atoms 311 from infiltrating the pores in a top surface of the ceramic dielectric layer 21 and decreasing the flatness of the arrangement of the copper atoms 311.

A dielectric constant of a material reflects its capability of storing electric energy. A dielectric constant is directly proportional to the capability of storing electric energy of a material. In the invention, the better flatness of copper atoms 311 may increase a dielectric constant of the copper electrode layer 22a, 22b. Moreover, graphene has higher dielectric constant than copper and the dielectric constant of the copper electrode layer 22a, 22b may further increased. Thus, the manufacturing method for a multi-layer ceramic capacitor structure of the invention may have a multi-layer ceramic capacitor made thereby satisfies the dielectric constant required in the industry and improve a yield rate.

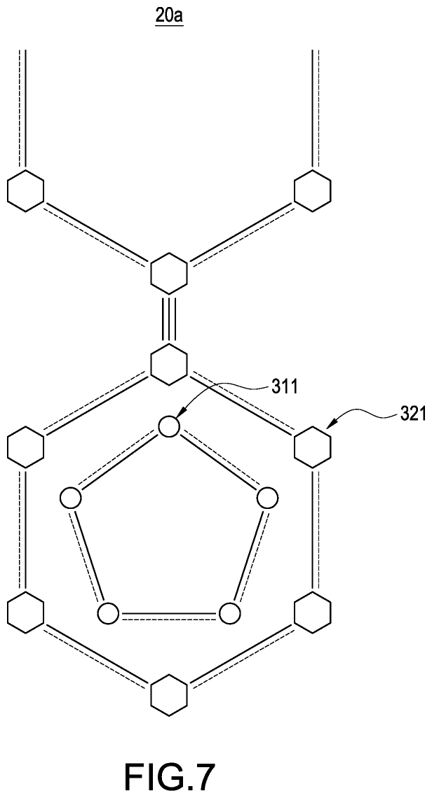

As shown in FIG. 7, in the copper electrode layer 22a, 22b, the graphene molecules 321 are connected by hybrid orbital SP³ bonds. Every six of the graphene molecules 321 are bonded to form a ring structure. The inner side of each ring structure is bonded with five copper atoms 311. The outer side of each ring structure is bonded to another ring structure. The connected ring structures may be a graphene planarly extended and connected in a laminar shape. The ring structure may also be laminated to increase the layers of graphene. The graphene molecules 321 are connected and planarly extend along a top surface of the ceramic dielectric layer 21, and the copper atoms 311 are restricted by the ring structure of graphene. The copper atoms 311 are confined to be the laminar shape to improve flatness of copper atoms 311 in the copper electrode layer 22a, 22b.

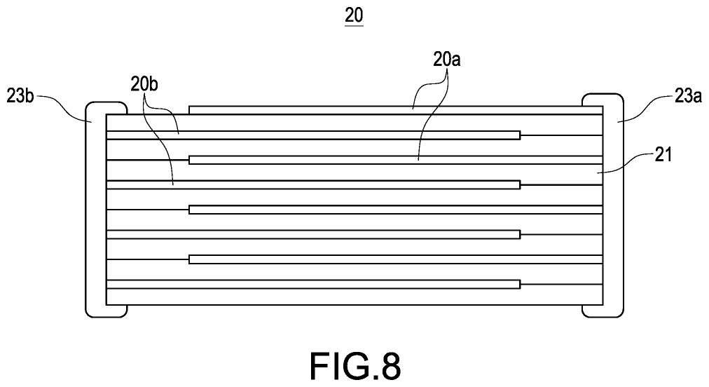

A multi-layer ceramic capacitor structure made by the above method is shown in FIGS. 7 and 8. The multi-layer ceramic capacitor structure includes a multi-layer structure 20 and a pair of outer electrodes 23 respectively covering a pair of side edges of the multi-layer structure 20. The multi-layer structure includes multiple ceramic dielectric layers 21 which are arranged laminatedly and a copper electrode layer 22a, 22b is sandwiched between any adjacent two of the ceramic dielectric layers 21. The copper electrode layer 22a, 22b includes multiple graphene molecules 321 and multiple copper atoms 311. The graphene molecules 321 and the copper atoms 311 are connected and arranged in a laminated manner. One of the outer electrodes 23 connects to a part of the copper electrode layer 22a, and another one of the outer electrodes 23 connects the rest of the copper electrode layers 22b.

Every six of the graphene molecules 321 are bonded to form a ring structure. The inner side of each ring structure is bonded with five copper atoms 311. The outer side of each ring structure is bonded to another ring structure. The graphene molecules may be connected and planarly extend along a top surface of the ceramic dielectric layer 21 and connected to the laminated ring structures.

It will be appreciated by persons skilled in the art that the above embodiments have been described by way of example only and not in any limitative sense, and that various alterations and modifications are possible without departure from the scope of the invention as defined by the appended claims.

What is claimed is:

1. A manufacturing method for a multi-layer ceramic capacitor structure, the method comprising:
a) providing a plastic film;
b) coating a layer of ceramic slurry on a side of the plastic film;
c) coating a layer of copper paste on the layer of ceramic slurry to form a raw material, wherein the copper paste at least comprises a copper powder and a graphene powder; and
d) sintering the raw material at a temperature equal to or higher than 800° C. to sinter the layer of ceramic slurry into a ceramic dielectric layer and the copper paste into a copper electrode layer.

2. The method of claim 1, wherein the plastic film provided in step a) is of a strip shape, the raw material formed in step c) forms a material roll, the raw material roll is cut to be multiple raw material sheets in step c), and in step d), the raw material sheets are laminated to be a multi-layer structure in the same direction and the multi-layer structure is sintered.

3. The method of claim 1, wherein the raw material is sintered at a temperature equal to or lower than 1100° C. in step d).

4. The method of claim 1, wherein the raw material is sintered to evaporate the plastic film in step d).

5. The method of claim 1, wherein the copper paste comprises filled plastic material, and in step d), the raw material is sintered to evaporate the plastic material.

6. The method of claim 1, wherein the copper powder comprises multiple copper atoms, the graphene powder comprises multiple graphene molecules, every six of the graphene molecules are bonded to form a ring structure, and an inner side of each ring structure is bonded with five copper atoms.

7. The method of claim 6, wherein an outer side of each ring structure is bonded to another ring structure.

8. The method of claim 7, wherein the ring structures are planarly extended and connected.

9. The method of claim 7, wherein the ring structures are arranged in a laminated manner.

10. The method of claim 1, wherein a weight percentage of the copper powder comprised in the copper paste is between 50% and 65%.

11. A multi-layer ceramic capacitor structure, comprising:
a multi-layer structure, comprising multiple ceramic dielectric layers arranged laminatedly, and a copper electrode layer sandwiched between any adjacent two of the ceramic dielectric layers;
wherein the coper electrode layer comprises multiple graphene molecules and multiple copper atoms, and the graphene molecules and the copper atoms are connected and arranged laminatedly.

12. The multi-layer ceramic capacitor structure of claim 11, wherein every six of the graphene molecules are bonded to form a ring structure, and an inner side of each ring structure is bonded with five copper atoms.

13. The multi-layer ceramic capacitor structure of claim 12, wherein an outer side of each ring structure is bonded to another ring structure.

14. The multi-layer ceramic capacitor structure of claim 13, wherein the ring structures are planarly extended and connected.

15. The multi-layer ceramic capacitor structure of claim 13, wherein the ring structures are arranged in a laminated manner.

16. The multi-layer ceramic capacitor structure of claim 11, further comprising: a pair of outer electrodes respectively covering a pair of side edges of the multi-layer structure, wherein one of the outer electrodes connects to a part of the copper electrode layer, and another one of the outer electrodes connects the rest of the copper electrode layers.
